(19) United States
(12) Patent Application Publication
(10) Pub. No.: US 2023/0172211 A1
(43) Pub. Date: Jun. 8, 2023

(54) SPRAY FORMULATIONS COMPRISING METAL NANOPARTICLE AGGLOMERATES AND SURFACE DISINFECTION THEREWITH

(71) Applicant: KUPRION INC., San Jose, CA (US)

(72) Inventors: Alfred A. ZINN, Palo Alto, CA (US); Randall M. STOLTENBERG, Palo Alto, CA (US)

(73) Assignee: KUPRION INC., San Jose, CA (US)

(21) Appl. No.: 17/995,487

(22) PCT Filed: Apr. 22, 2021
(86) PCT No.: PCT/US2021/028546

§ 371 Date: Oct. 5, 2022

Related U.S. Application Data
(60) Provisional application No. 63/013,732, filed on Apr. 22, 2020.

(51) Int. Cl. A01N 59/20; A01N 25/06; A01N 25/28

(52) U.S. Cl. CPC A01N 59/20; A01N 25/06; A01N 25/28

(57) ABSTRACT

Spray formulations comprising metal nanoparticle agglomerates dispersed in an aerosolizable fluid medium may be utilized to promote disinfection of various types of surfaces and/or to facilitate reuse of masks and other types of personal protective equipment. The spray formulations may be dispensed using an aerosol propellant, or by mechanical pumping or gas compression. Metal nanoparticles, such as copper and/or silver nanoparticles, may be present in the spray formulations and aid in inactivating pathogens such as viruses and bacteria once the spray formulations have been deposited upon a surface. An adhesive may be present in the spray formulations to promote adherence of metal nanoparticle agglomerates to the surface.

### BACKGROUND

The world is facing increasing threats from antibiotic-resistant strains of bacteria (i.e., “super bugs”) that cannot be effectively treated due, at least in part, to the overuse of antibiotics. Other types of resistant microorganisms can present similar issues. Increased population densities and efficient mass transit infrastructure have also contributed significantly to both localized and global spread of various diseases, including both common and emerging diseases. Common influenza and emerging viruses such as coronaviruses represent a significant health threat in this respect. Indeed, the ongoing COVID-19 pandemic represents one of the most significant health threats seen over the past century.

Masks and other types of personal protective equipment are often worn by infected and healthy individuals to limit the spread of disease, particularly in crowded locales or in medical facilities where there is an increased risk of person-to-person disease transmittal. In a healthcare setting, the use of masks and additional personal protective equipment may be even more critical. Under ordinary circumstances, there is a ready supply chain for providing masks and other personal protective equipment to both individuals and medical facilities. As such, most personal protective equipment is designed for a single use or minimal uses to limit the risk of cross-contamination when examining different patients or moving from one location to another. With the current COVID-19 pandemic, normal supply chains have been disrupted and demand for masks and other personal protective equipment has greatly outstripped supply. This shortage has increasingly led to non-preferred reuse of personal protective equipment, which may greatly increase the risk of infections that might otherwise be avoided by discarding personal protective equipment after a single use. These risks extend to both caregivers and patients. Pathogen transfer from contaminated personal protective equipment to various touch surfaces may also be a significant concern. Direct contamination of touch surfaces with pathogens may likewise be problematic.

Some types of personal protective equipment are designed for limited reuse, albeit with some risks associated therewith. Indeed, masks, such as N95 masks, are often reused multiple times by a user, sometimes up to a month in time. The high surface area of the mask and the moist environment generated by passage of exhaled breath therethrough can create a fertile breeding ground for bacteria or other pathogens trapped by the mask. Trapped viruses in combination with pathogenic or non-pathogenic bacteria may represent a particular risk due to rapid growth of the bacteria in the mask environment.

Masks need to be handled carefully to prevent cross-contamination when worn from one area and another, particularly as the mask ages and the risk of contamination grows. Pathogen transfer to various touch surfaces may arise from adjustment of contaminated masks, not to mention the risk borne by a person wearing a contaminated mask. In addition, used masks represent a significant biohazardous waste disposal issue, since they have to processed as if contaminated, even if they are not.

To facilitate reuse of masks in response to supply concerns and to limit the risk of cross-contamination, masks may be disinfected, such as through soaking in or spraying a disinfectant solution. Current disinfection protocols for masks include exposing the masks to H₂O₂ along with UV light exposure. While effective for disinfection in the short-term, it may take a long time for the mask to dry out for continued use, and the structural integrity of the mask may be compromised by repeated cycles of disinfection and wear. Most masks can only be disinfected a few times with currently existing protocols. For example, rubber straps and the filtration medium of masks may fall apart following extended exposure to hydrogen peroxide and UV light. Other personal protective equipment is even more fragile and cannot be easily disinfected to facilitate further reuse.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and the benefit of this disclosure.

FIG. 1 shows a diagram of the presumed mechanism of action of cisplatin compounds.

FIGS. 2 and 3 show diagrams of presumed structures of metal nanoparticles having a surfactant coating thereon.

FIG. 4 shows an illustrative SEM image of substantially individual copper nanoparticles.

FIG. 5 shows an illustrative SEM image of an agglomerate of copper nanoparticles.

FIG. 6 shows an illustrative SEM image of a copper nanoparticle network obtained after fusion of a plurality of copper nanoparticles to each other.

FIGS. 7A and 7B show illustrative SEM images of copper nanoparticles disposed upon textile fibers of a mask.

FIG. 8 shows an illustrative photographic image of a fabric having agglomerates of copper nanoparticles adhered thereto, as fabricated (left side of image) and after extended use (right side of image).

### DETAILED DESCRIPTION

The present disclosure relates to spray formulations comprising metal nanoparticle agglomerates, which may be used to promote disinfection of masks and other personal protective equipment (PPE), as well as to promote disinfection of various touch surfaces. Once deposited upon PPE or a touch surface, the metal nanoparticle agglomerates may convey antiseptic activity thereto, including PPE and touch surfaces that do not otherwise display antiseptic activity. Thus, touch surfaces may be disinfected through application of the spray formulations disclosed herein thereto. Long-lasting infection control compared to liquid disinfectants may be realized, such that the surfaces become essentially self-sterilizing after application of metal nanoparticle agglomerates thereto. Metal nanoparticles are uniquely situated to convey the foregoing features, since they are readily capable of inactivating a wide range of microorganisms and viruses, including coronaviruses, are low toxicity to humans, especially in small amounts, and may be readily processed into spray formulations according to the disclosure herein. Metal nanoparticle agglomerates may be particularly advantageous in regard to the foregoing, as discussed further below.

As used herein, the terms “spray formulation,” “antiseptic spray,” “disinfectant spray,” and similar terms refer to an aerosolizable fluid medium comprising metal nanoparticles agglomerates, as specified further herein. The aerosolizable fluid medium may be dispensed with an aerosol propellant, such as via a compressed low-boiling fluid, or through pumping or gas pressurization to produce spray droplets. Aerosol propellants may afford sprayed droplet sizes ranging from about 10-150 microns, whereas pumped or pressurized sprays may afford a slightly larger droplet size in a range of about 150-400 microns.

Advantageously, the spray formulations disclosed herein may aid in alleviating current supply chain burdens by facilitating reuse of personal protective equipment, such as masks. The spray formulations may also be utilized to provide additional antiseptic activity to masks and other PPE, which may not otherwise be enhanced with an antiseptic substance. Long-lasting antiseptic activity or infection control may be realized, including in a time-release manner, when employing metal nanoparticle agglomerates within a spray formulation.

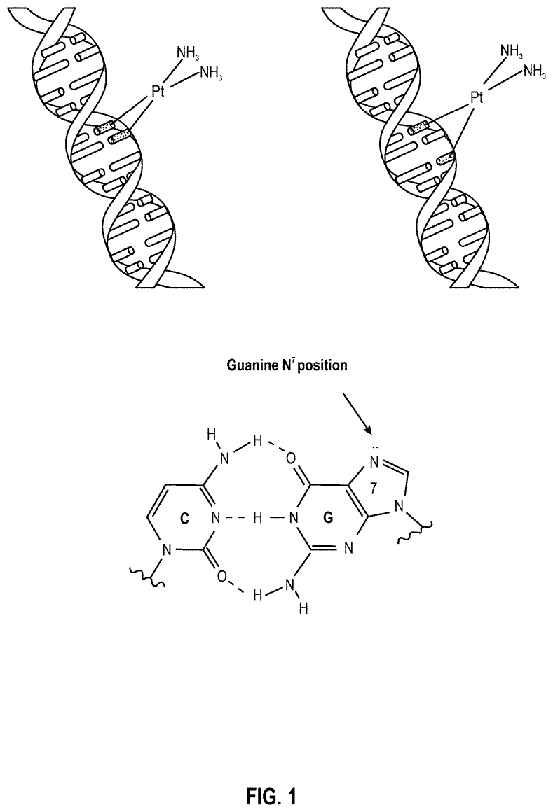

In addition to facilitating reuse of masks and other PPE, the spray formulations disclosed herein may be utilized for promoting rapid disinfection of touch surfaces in various locations, but particularly in a medical setting. Illustrative touch surfaces that may be disinfected by applying metal nanoparticle agglomerates thereto through spraying include, for example, door knobs, doors, countertops, desktops, light switches, appliances, computer equipment, keyboards, pens, clip boards, privacy curtains, walls, elevator buttons, door access buttons and keypads, ATM keypads and screens, shopping carts, self-service checkout stations, self-service, gas pumps, shoes, gloves, and the like. Dry wipes impregnated with metal nanoparticle agglomerates, either directly or through spraying, also may be effectively used to promote disinfection of a surface in a similar manner. In either case, enhanced protection against viruses (including coronaviruses), bacteria, and other pathogens may be realized. Without being bound by any theory, the mechanism of action of metal nanoparticles against various pathogens may result from biomolecule interaction with the metal nanoparticles. With respect to DNA, the mechanism of action may be similar to that of platinum coordination compounds (e.g., cisplatin, carboplatin, oxaliplatin, and pyriplatin), as illustratively shown in FIG. 1. Metal nanoparticle agglomerates may represent a particularly advantageous form of metal nanoparticles for promoting infection control, as discussed further below.

For example, the mechanism of action of metal nanoparticles may address mutations and antibiotic resistance that are becoming increasingly frequent with common disinfectants and pharmaceuticals. Whereas these agents may function through competitive inhibition, metal nanoparticles may facilitate multiple biocidal pathways and lead to more effective biocidal activity that is more resistant to mutations

Silver and copper surfaces both possess antibacterial activity, even against antibiotic-resistant bacteria in some instances. Bulk copper surfaces, for example, may afford viral inactivation in about 4 hours in some cases. Silver surfaces tend to be less active and the cost of silver relative to copper may be prohibitive. In addition, copper surfaces are capable of inactivating some viruses, such as coronaviruses, which may otherwise remain active for up to five days on other types of surfaces, such as glass, polymers, ceramics, rubber, paper, and stainless steel, for example. Unfortunately, it is difficult to incorporate metallic silver or metallic copper upon the foregoing surface types due to the high melting point of these metals. Molten copper, for instance, forms at the melting point of copper (1083° C.), a temperature which is completely incompatible with the materials present in many surface types, including those present in masks, other types of PPE, and many types of touch surface. The melting point of silver is likewise problematically high. Micron-size silver or copper particles or flakes may be produced and introduced as solids to a surface in need of infection control, but it may be difficult to promote sufficient adherence of the particles or flakes to a surface to afford robust performance. In addition, it may be difficult to formulate micron-size metal particles or flakes into a form suitable for rapid dispensation upon PPE or a touch surface, particularly by spraying.

As a solution to the foregoing, metal nanoparticle agglomerates may be formulated such that they may be readily applied through spraying onto various types of surface in need of disinfection or infection control. Spray formulations comprising metal nanoparticle agglomerates may comprise an aerosolizable fluid medium, from which an aerosol or similar droplets comprising metal nanoparticle agglomerates may be generated following spray dispensation. The aerosolizable fluid medium may be a gas or highly volatile liquid at room temperature and pressure, such that metal nanoparticle agglomerates may be rapidly deposited upon a surface, such as on the fibers of a mask or other PPE, with the surface being obtained in dry form essentially immediately or soon after spraying the metal nanoparticles agglomerates thereon. Suitable spray formulations may utilize an aerosol propellant for promoting forced-pressure dispensation (optionally in combination with a solvent for dispersing the metal nanoparticle agglomerates) or a volatile solvent for pumping or gas-pressurization dispensation. Aerosol propellants may be particularly desirable due to their essentially instantaneous evaporation from a surface or even prior to contacting a surface.

Spray formulations comprising metal nanoparticle agglomerates may allow various types of surfaces to be rapidly disinfected against a range of pathogens, which may lessen the occurrence of cross-contamination and permit more facile and rapid reuse of masks and other PPE to be realized without prematurely compromising mechanical integrity thereof. In addition, metal nanoparticles and agglomerates thereof, properties of which are addressed in further detail below, represent a highly reactive metal form that may undergo ready adherence to a range of surfaces once deposited in small droplet form thereon. The ready surface adherence may extend the time period required between subsequent disinfections and lengthen the effective lifetime of masks and other PPE. Infection control may be maintained for 1-3 months when the masks and PPE are sealed in a bag, and even for 6 months or more when storage is conducted under inert atmosphere.

Metal nanoparticle agglomerates represent a particularly advantageous construct for incorporating a metal onto a surface through spray dispensation. Copper nanoparticles and/or silver nanoparticles and their agglomerates may be particularly advantageous for promoting disinfection or infection control, given the known biocidal activity of bulk copper and silver surfaces. Nanoparticle forms of these metals may provide an especially advantageous vehicle for introducing metal onto a surface due to robust surface adherence that may be realized when agglomerates of these metal nanoparticles are applied to a surface through spraying, particularly when a spray formulation contains both metal nanoparticle agglomerates and an adhesive. Copper nanoparticles and silver nanoparticles used in combination with one another may afford complementary biocidal against the same or different pathogens than may be targeted or inactivated by each metal individually. Copper may be advantageous relative to silver due to its lower cost, potential lower in vivo toxicity relative to silver, and in vivo function as an essential nutrient and regulator of several biological processes (e.g., protein function, angiogenesis, and energy production). Zinc, nickel, titanium and other bioactive metals, as well as their oxide forms, may be utilized in further combination with either or both of these metals as well and/or oxides of copper and/or silver.

Metal nanoparticles, such as silver and copper nanoparticles, can be readily produced in agglomerated form in a size range that is compatible for processing into spray formulations that may be suitable for deposition upon a range of surfaces. The small size of the metal nanoparticles and their agglomerates allows ready dispersion in an aerosolizable fluid medium and aerosolized droplet formation to be realized, while simultaneously facilitating robust surface adherence. Depending on the aerosolizable fluid medium used and the technique for dispensation thereof, the aerosolized droplet size may range from about 10-150 microns for aerosol sprays and from about 150-400 microns for pumped or gas-pressurized sprays. The aerosolized droplets are easily directed to a specified location and do not linger overly long in air before settling on a surface. In addition, the small size of the metal nanoparticles conveys a high surface energy thereto, which may result in the metal nanoparticle agglomerates becoming surface-adhered following aerosolized droplet formation and deposition upon a surface, thereby providing a robust structure that is capable of repeated handling during use and potentially extending the time needed between subsequent disinfectant treatments. The high surface energy may afford chemical bond formation to the surface in some instances. An adhesive may further facilitate adherence of metal nanoparticle agglomerates to a surface, as well as provide other advantages, as discussed hereinafter. The metal nanoparticles within metal nanoparticle agglomerates may retain their nanoparticulate structure following deposition on a surface, as discussed in further detail hereinafter.

As indicated above, an adhesive may further promote adherence of metal nanoparticle agglomerates to a surface, particularly before the metal nanoparticles' high surface energy has afforded more robust bonding. The adhesive, which may be permanently tacky, may be applied concurrently with the metal nanoparticles agglomerates (i.e., in a spray formulation) or separately. Application of an adhesive to a surface prior to deposition of metal nanoparticle agglomerates thereon via spraying may afford initial sequestration of the metal nanoparticles during deposition, followed by more robust adherence being realized through surface bonding taking place as a result of the high surface energy of the metal nanoparticles. As a further advantage, the adhesive may promote prolonged release of active metal species from metal nanoparticle agglomerates following their adherence to a surface, as discussed further below. Once metal nanoparticle agglomerates have been introduced to a surface through spraying, particularly in the presence of a suitable adhesive, biocidal activity may be maintained over an extended time, such as over a period of days to weeks.

As used herein, the term “metal nanoparticles” refers to metal particles that are about 250 nm or less in size, particularly about 200 nm or less in size or about 150 nm or less in size, without particular reference to the shape of the metal particles. Copper nanoparticles are metal nanoparticles comprising predominantly copper, optionally with an oxide coating wholly or partially covering the surface of the copper nanoparticles. Likewise, silver nanoparticles are metal nanoparticles comprising predominantly silver, optionally with an oxide coating wholly or partially covering the surface of the silver nanoparticles. The term “metal nanoparticle” broadly refers herein to any metallic structure having at least one dimension of 250 nm or less, particularly about 200 nm or less or about 150 nm or less and includes other structures that are not substantially spherical in nature, such as metal platelets/disks, metal nanowires, or the like. Other metal nanostructures that may be dispersed in a spray formulation, as discussed herein, may be used in addition to or as alternatives to agglomerates of spherical or substantially spherical metal nanoparticles in the disclosure herein.

The term “metal nanoparticle agglomerates” and equivalent grammatical forms thereof refers to a grouping of metal nanoparticles having at least one dimension ranging from about 0.1 microns to about 35 microns in size, particularly about 0.1 microns to about 15 microns in size, and more particularly about 0.1 microns to about 5 microns in size. Individual metal nanoparticles within a metal nanoparticle agglomerate may reside within the size ranges indicated above, and the individual metal nanoparticles may be associated with one another through non-covalent, covalent, or metallic bonding interactions. The term “associated” refers to any type of bonding force that holds a grouping of metal nanoparticles together. The bonding force may be overcome to produce individual metal nanoparticles or smaller metal nanoparticle agglomerates in some instances.

The terms “consolidate,” “consolidation” and other variants thereof are used interchangeably herein with the terms “fuse,” “fusion” and other variants thereof. These terms refer to at least partial coalescence of metal nanoparticles.

Once a surfactant coating has been lost from the surface of metal nanoparticles, as discussed further below, surface oxidation of the metal nanoparticles may lead to formation of reactive and potentially mobile salt compounds, including oxides, upon a surface where the metal nanoparticles are applied. The salt compounds may be present as a surface coating upon at least a portion of the metal nanoparticles. Such salts may include, for example, chlorides, bisulfites and bicarbonates, resulting from chloride in sweat, carbon dioxide or sulfur dioxide in air or breath, or the like. Formation of such salts may be particularly prevalent upon exposure of the metal nanoparticles to a moist environment, as specified in Reactions 1 and 2 below. Dry conditions, in contrast, may favor formation of at least a partial oxide coating upon the surface of the metal nanoparticles, as specified in Reaction 3 below.

Cu+½ O₂+H₂O+2 CO₂→CU(HCO₃)₂ (Reaction 1)

CU+½ O₂+H₂O+2 SO₂→CU(HSO₃)₂ (Reaction 2)

Cu+½ O₂→Cu₂O (Reaction 3)

The salts may be surfactant-stabilized salt complexes comprising one or more surfactants (e.g., one or more amine surfactants in the case of copper nanoparticles, and sufficient salt anions to achieve charge balance). Charge balancing anions may include, for example, halogen, particularly chloride; bisulfite; bicarbonate; acetate; formate; lactate; or the like. The charge balancing anions are relatively labile and may be released to generate open coordination sites for binding DNA, proteins, or the like. The metal salts or surfactant-stabilized salt complexes may remain relatively mobile upon a surface, even when bound within an adhesive, and provide a higher effective coverage of metal nanoparticles upon a surface than if they remained fully fixed in place.

Before further discussing more particular aspects of the present disclosure in more detail, additional brief description of metal nanoparticles and their processing conditions, particularly silver or copper nanoparticles, will first be provided. Metal nanoparticles exhibit a number of properties that can differ significantly from those of the corresponding bulk metal. One property of metal nanoparticles that can be of particular importance for processing is nanoparticle fusion (consolidation) that occurs at the metal nanoparticles' fusion temperature. As used herein, the term “fusion temperature” refers to the temperature at which a metal nanoparticle liquefies, thereby giving the appearance of melting. At or above the fusion temperature, consolidation with other metal nanoparticles may readily take place. As used herein, the terms “fusion” and “consolidation” synonymously refer to the coalescence or partial coalescence of metal nanoparticles with one another to form a larger mass. Once disposed upon a surface, individual metal nanoparticles or metal nanoparticles within metal nanoparticle agglomerates may undergo fusion with one another as well, thereby forming a network of at least partially fused metal nanoparticles in either case. In other particular examples, metal nanoparticles in the metal nanoparticle agglomerates may remain unfused to one another when adhered to a surface or present in a spray formulation. Metal nanoparticle agglomerates result when metal nanoparticles associate together prior to deposition upon a surface but individual metal nanoparticles are still identifiable.

Advantageously and surprisingly, metal nanoparticles, such as silver and/or copper nanoparticles can become adhered to various surfaces even well below their fusion temperature, thereby allowing surface bonding to take place, as discussed further herein. Depending on the density at which the silver and/or copper nanoparticles are loaded onto a surface in need of disinfection and the temperature at which they are processed thereon, individual metal nanoparticles or metal nanoparticles within metal nanoparticle agglomerates may or may not be further fused together when adhered to the surface. Desirably, the metal nanoparticles within metal nanoparticle agglomerates may remain at least partially unfused to facilitate time-release of metal nanoparticles and metal nanoparticle clusters (smaller agglomerates) from larger metal nanoparticle agglomerates upon a surface, but not in a form such that they are potentially releasable in free form in vivo. Oxidized forms of metal nanoparticles or metal nanoparticle clusters may be released from metal nanoparticle agglomerates upon a surface as well. When applying a spray formulation containing metal nanoparticle agglomerates to a surface, such as masks, other PPE or touch surfaces, further heating may or may not be performed, depending upon the level of disinfection and surface bonding desired. Preferably, the temperature may remain sufficiently low during deposition or afterward such that the metal nanoparticles do not become fused together upon the surface, although they may be. Even when metal nanoparticles remain as individual metal nanoparticles or agglomerates thereof, robust surface adherence may still be realized.

When seeking to facilitate biocidal activity, metal nanoparticle agglomerates may be advantageous in several respects compared to individual metal nanoparticles. Individual metal nanoparticles, particularly metal nanoparticles smaller than about 50 nm or about smaller than about 20 nm, may react and lose their biocidal activity rather quickly. Metal nanoparticle agglomerates, in contrast, are more stable and may convey a time-release profile of individual metal nanoparticles that is sustained over multiple days, up to about 30 days, for instance. Metal nanoparticle agglomerates of different sizes may extend the range over which suitable biocidal activity may be displayed. In addition, metal nanoparticle agglomerates have a tortuous, complex surface that provides a high surface area for capturing bacteria, viruses, and other pathogens, and promoting inactivation thereof.

Upon decreasing in size, particularly below about 20 nm in equivalent spherical diameter, the temperature at which metal nanoparticles liquefy drops dramatically from that of the corresponding bulk metal. For example, copper nanoparticles having a size of about 20 nm or less can have fusion temperatures of about 220° C. or below, or about 200° C. or below, or even about 175° C. or below in comparison to bulk copper's melting point of 1083° C. Silver nanoparticles may similarly display a significant deviation from the melting point of bulk silver below a nanoparticle size of about 20 nm. Thus, the consolidation of metal nanoparticles taking place at the fusion temperature as a result of the high surface energy can allow structures containing bulk metal to be fabricated at significantly lower processing temperatures than when working directly with the bulk metal itself as a starting material. The small particle sizes of the metal nanoparticles and their agglomerates may promote ready dispersion within an aerosolizable fluid medium for processing into spray formulations for disinfectant applications according to the disclosure herein. Agglomerates of the metal nanoparticles, wherein the metal nanoparticles are unfused but are associated together, may likewise be dispersible in aerosolizable fluid media for processing into suitable disinfectant sprays. Once deposited from a spray formulation upon PPE or another suitable surface, metal nanoparticle agglomerates may become adhered thereto as a consequence of the high surface energy of the metal nanoparticles. Adherence may be further promoted by an adhesive, as discussed further herein.

A number of scalable processes for producing bulk quantities of metal nanoparticles in a targeted size range have been developed. Most typically, such processes for producing metal nanoparticles take place by reducing a metal precursor in the presence of one or more surfactants. The as-isolated metal nanoparticles may have a surfactant coating thereon and be isolated as a plurality of nanoparticle agglomerates. The agglomerates may be broken apart, while retaining the surfactant coating, or the agglomerates may be used directly without further processing. Particularly advantageous metal nanoparticle agglomerates for spray formulations and promoting infection control may include metal nanoparticles ranging from about 50 nm to about 250 nm in size, or about 50 nm to about 150 nm in size. The agglomerates may convey a time-release profile for providing individual metal nanoparticles or smaller metal nanoparticle clusters upon a surface, thereby facilitating surfactant loss from individual metal nanoparticles and activation thereof, particularly in the presence of moisture. While present, the surfactants themselves may facilitate surface adhesion through van der Waals interactions, optionally aided by an adhesive.

Metal nanoparticles or agglomerates thereof can be isolated and purified from a reaction mixture by common isolation techniques and processed into a suitable spray formulation for surface dispensation. The surfactant coating of the metal nanoparticles may be removed through gentle heating, gas flow, and/or vacuum (any pressure below atmospheric pressure) once the metal nanoparticles have been deposited upon a surface, thereby affording a much higher surface energy and a commensurate increase in reactivity and biocidal activity. Alternately, the surfactant coating may be lost upon extended contact with the surface without undergoing additional heating or other processing, with surface adherence occurring with surfactant loss. The surfactant coating may remain for at least some period of time upon the surface, such that the metal nanoparticles are retained as individuals. Once the surfactant coating has been removed, the high surface energy of the metal nanoparticles may facilitate adherence of the metal nanoparticles to the surface. The metal nanoparticles may or may not become fused together during this process. At least some surface adhesion may also be realized without the surfactant coating being removed.

Metal nanoparticle agglomerates having a range of sizes, such as those within a range of about 0.1 microns to about 35 microns, or about 0.1 microns to about 15 microns, or about 0.1 microns to about 5 microns, or about 0.5 microns to about 5 microns may be advantageous in terms of their ability to be dispersed in an aerosolizable fluid medium and dispensed through aerosol formation or formation of sprayed droplets. Additional benefits may be realized once the metal nanoparticle agglomerates have become adhered to a surface following loss of a surfactant coating or through bonding to an adhesive layer. In particular, metal nanoparticle agglomerates may “shed” individual metal nanoparticles or small clusters of metal nanoparticles that are highly active and possess a significant degree of biocidal activity. Once released, the individual metal nanoparticles or small clusters of metal nanoparticles may migrate over the surface but without being released therefrom. By differentially releasing metal nanoparticles from metal nanoparticle agglomerates having a range of sizes, a time-release profile of metal nanoparticles may be realized to afford prolonged and rapid infection control and disinfection capabilities. Efficacy over the period of time-release may be based upon the total loading of metal nanoparticle agglomerates per unit area. Thus, biocidal activity against various pathogens may be retained over several days, such as at least about 3 days, or at least about 5 days, or at least about 7 days, or at least about 10 days, or at least about 14 days, or at least about 21 days, or at least about 30 days. An adhesive layer in contact with the metal nanoparticle agglomerates may further facilitate a time-release profile of metal nanoparticles for conveying biocidal activity. Suitable adhesives within an adhesive layer are not considered to be particularly limited and are specified in more detail below.

Any suitable technique can be employed for forming the metal nanoparticles used in the disclosure herein. Particularly facile metal nanoparticle fabrication techniques, particularly for copper nanoparticles, are described in U.S. Pat. Nos. 7,736,414, 8,105,414, 8,192,866, 8,486,305, 8,834,747, 9,005,483, 9,095,898, and 9,700,940, each of which is incorporated herein by reference in its entirety. Similar procedures may be used for synthesizing silver nanoparticles. As described therein, metal nanoparticles can be fabricated in a narrow size range by reduction of a metal salt in a solvent in the presence of a suitable surfactant system, which can include one or more different surfactants. Further description of suitable surfactant systems follows below. Tailoring of the surfactant system, the reaction concentration, temperature, and like factors may determine the size range of metal nanoparticles that are obtained from a metal nanoparticle synthesis. Without being bound by any theory or mechanism, it is believed that the surfactant system can mediate the nucleation and growth of the metal nanoparticles, limit surface oxidation of the metal nanoparticles while the surfactant system is adhered thereto, and/or inhibit metal nanoparticles from extensively aggregating with one another prior to being at least partially fused together. As noted above, small agglomerates of metal nanoparticles may be formed in many instances and used in the disclosure herein. Suitable organic solvents for solubilizing metal salts and forming metal nanoparticles can include, for example, formamide, N,N-dimethylformamide, dimethyl sulfoxide, dimethylpropylene urea, hexamethylphosphoramide, tetrahydrofuran, glyme, diglyme, triglyme, tetraglyme, proglyme, or polyglyme. Reducing agents suitable for reducing metal salts and promoting the formation of metal nanoparticles can include, for example, an alkali metal in the presence of a suitable catalyst (e.g., lithium naphthalide, sodium naphthalide, or potassium naphthalide) or borohydride reducing agents (e.g., sodium borohydride, lithium borohydride, potassium borohydride, or tetraalkylammonium borohydrides). In non-limiting examples, reduction of the metal salt to form metal nanoparticles and agglomerates thereof may take place under substantially anhydrous conditions in a suitable organic solvent.

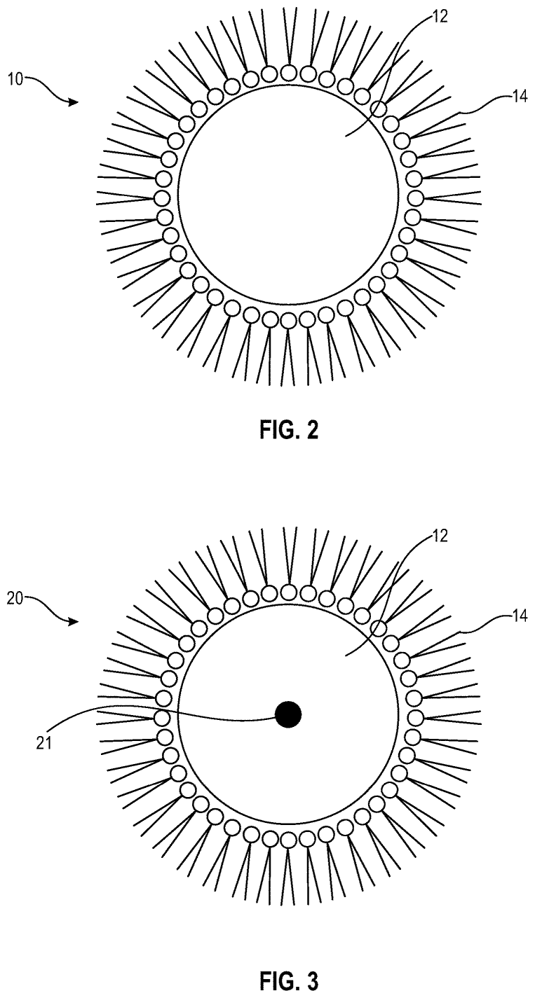

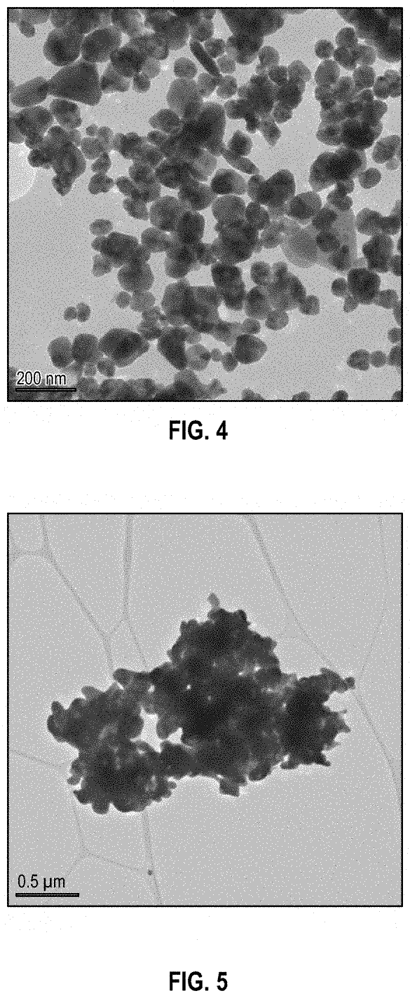

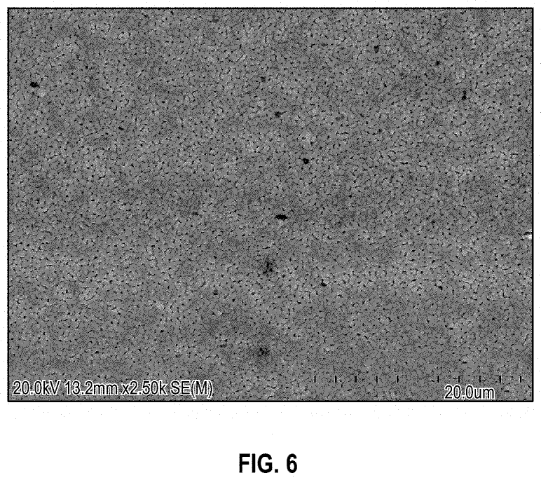

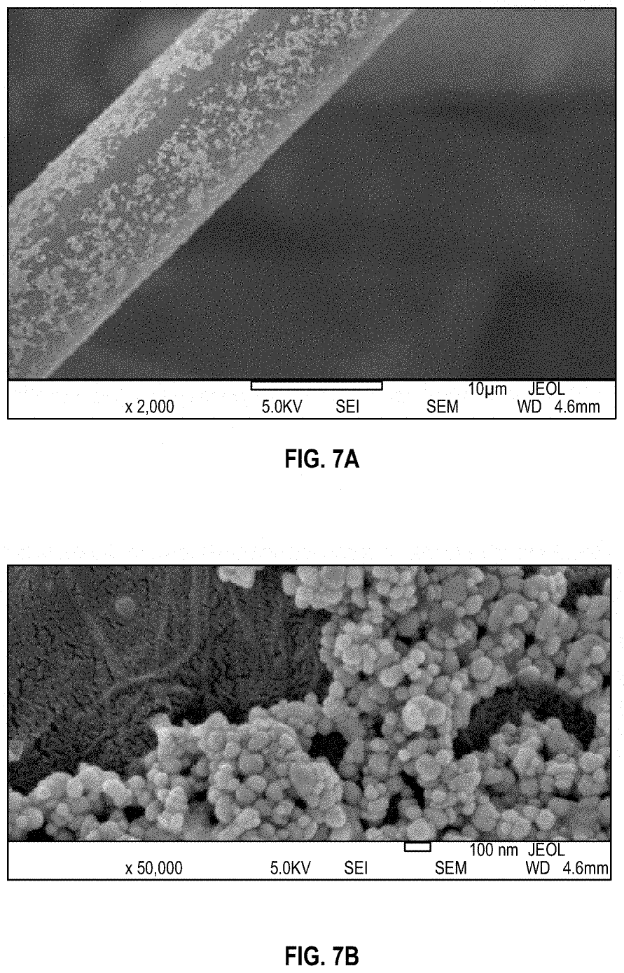

FIGS. 2 and 3 show diagrams of presumed structures of metal nanoparticles having a surfactant coating thereon. As shown in FIG. 2, metal nanoparticle 10 includes metallic core 12 and surfactant layer 14 overcoating metallic core 12. Surfactant layer 14 can contain any combination of surfactants, as described in more detail below. Metal nanoparticle 20, shown in FIG. 3, is similar to that depicted in FIG. 2, except metallic core 12 is grown about nucleus 21. Because nucleus 21 is buried deep within metallic core 12 in metal nanoparticle 20 and is very small in size, it is not believed to significantly affect the overall nanoparticle properties. Nucleus 21 may comprise a salt or a metal, wherein the metal may be the same as or different than metallic core 12. In some embodiments, the nanoparticles can have an amorphous morphology. FIGS. 2 and 3 may be representative of the microscopic structure of metal nanoparticles suitable for use in the disclosure herein. FIG. 4 shows an illustrative SEM image of substantially individual copper nanoparticles. FIG. 5 shows an illustrative SEM image of an agglomerate of copper nanoparticles, which may be used in the disclosure herein. FIG. 6 shows an illustrative SEM image of a copper nanoparticle network obtained after fusion of a plurality of copper nanoparticles to each other. FIGS. 7A and 7B show illustrative SEM images of copper nanoparticles adhered to the surface of a mask following spraying thereon. The copper nanoparticles are robustly adhered to textile fibers of the mask surface but do not undergo fusion with one another.

As discussed above, the metal nanoparticles have a surfactant coating containing one or more surfactants upon their surface. The surfactant coating can be formed on the metal nanoparticles during their synthesis. Formation of a surfactant coating upon metal nanoparticles during their syntheses can desirably limit the ability of the metal nanoparticles to fuse to one another prematurely, limit agglomeration of the metal nanoparticles to a desired extent or agglomerate size, and promote the formation of a population of metal nanoparticles having a narrow size distribution. At least partial loss of the surfactant coating may occur upon heating the metal nanoparticles up to the fusion temperature, including at least some surfactant loss well below the fusion temperature for low-boiling surfactants. Surfactant loss may be further promoted by flowing gas and/or application of vacuum (reduced pressure), as desired, even below the fusion temperature. At least some surfactant loss may occur, given sufficient time, at room temperature and ambient pressure conditions in some instances. Following surfactant loss, fusion of the metal nanoparticles may take place above or below the fusion temperature. If uncoated metal nanoparticles remain unfused, a high surface energy may be obtained. The high surface energy may promote adherence of the metal nanoparticles to a mask or touch surface, even below the fusion temperature. When heated above the fusion temperature, nanoparticle fusion may take place in combination with the metal nanoparticles becoming adhered to a surface. When copper nanoparticles and silver nanoparticles are present upon a surface together, fusion between the copper nanoparticles and the silver nanoparticles may occur as well. Combinations of copper nanoparticles and silver nanoparticles may afford particular synergy against pathogens not remediated adequately with a single metal alone, including conveying biocidal activity against different pathogens and/or enhancing activity against a particular pathogen.

Various types of metal nanoparticles may be synthesized by metal reduction in the presence of one or more suitable surfactants, such as copper nanoparticles or silver nanoparticles. Copper and/or silver can be particularly desirable metals for use in the embodiments of the present disclosure due to their ability to promote pathogen killing or inactivation when deposited upon a surface. Copper may also be advantageous due to its low cost. Zinc and zinc oxide can similarly display biocidal activity against bacteria, viruses and similar microorganisms and may be substituted for copper or silver in any of the embodiments disclosed herein, or used in combination with these metals. NiO and TiO₂ may be used similarly in this respect.

In various embodiments, the surfactant system present within the metal nanoparticles can include one or more surfactants. The differing properties of various surfactants can be used to tailor the properties of the metal nanoparticles and agglomerates thereof. Factors that can be taken into account when selecting a surfactant or combination of surfactants for inclusion upon the metal nanoparticles can include, for example, ease of surfactant dissipation from the metal nanoparticles during or prior to nanoparticle fusion, nucleation and growth rates of the metal nanoparticles to impact the nanoparticle size, the metal component of the metal nanoparticles, and the like. Main group metals, for example, may require different surfactants than do transition metals.

In some embodiments, an amine surfactant or combination of amine surfactants, particularly aliphatic amines, can be present upon the metal nanoparticles. Amine surfactants can be particularly desirable for use in conjunction with copper nanoparticles or silver nanoparticles due to their good affinity for these transition metals. In some embodiments, two amine surfactants can be used in combination with one another. In other embodiments, three amine surfactants can be used in combination with one another. In more specific embodiments, a primary amine, a secondary amine, and a diamine chelating agent can be used in combination with one another. In still more specific embodiments, the three amine surfactants can include a long chain primary amine, a secondary amine, and a diamine having at least one tertiary alkyl group nitrogen substituent. Further disclosure regarding suitable amine surfactants follows hereinafter.

In some embodiments, the surfactant system can include a primary alkylamine. In some embodiments, the primary alkylamine can be a C₂-C₁₈ alkylamine. In some embodiments, the primary alkylamine can be a C₇-C₁₀ alkylamine. In other embodiments, a C₅-C₆ primary alkylamine can also be used. Without being bound by any theory or mechanism, the exact size of the primary alkylamine can be balanced between being long enough to provide an effective inverse micelle structure during synthesis versus having ready volatility and/or ease of handling during nanoparticle consolidation. For example, primary alkylamines with more than 18 carbons can also be suitable for use in the present embodiments, but they can be more difficult to handle because of their waxy character. C₇-C₁₀ primary alkylamines, in particular, can represent a good balance of desired properties for ease of use.

In some embodiments, the C₂-C1₈ primary alkylamine can be n-hexylamine, n-heptylamine, n-octylamine, n-nonylamine, or n-decylamine, for example. While these are all straight chain primary alkylamines, branched chain primary alkylamines can also be used in other embodiments. For example, branched chain primary alkylamines such as, for example, 7-methyloctylamine, 2-methyloctylamine, or 7-methylnonylamine can be used. In some embodiments, such branched chain primary alkylamines can be sterically hindered where they are attached to the amine nitrogen atom. Non-limiting examples of such sterically hindered primary alkylamines can include, for example, t-octylamine, 2-methylpentan-2-amine, 2-methylhexan-2-amine, 2-methylheptan-2-amine, 3-ethyloctan-3-amine, 3-ethylheptan-3-amine, 3-ethylhexan-3-amine, and the like. Additional branching can also be present. Without being bound by any theory or mechanism, it is believed that primary alkylamines can serve as ligands in the metal coordination sphere but be readily dissociable therefrom during metal nanoparticle consolidation.

In some embodiments, the surfactant system can include a secondary amine. Secondary amines suitable for forming metal nanoparticles can include normal, branched, or cyclic C₄-C₁₂ alkyl groups bound to the amine nitrogen atom. In some embodiments, the branching can occur on a carbon atom bound to the amine nitrogen atom, thereby producing significant steric encumbrance at the nitrogen atom. Suitable secondary amines can include, without limitation, dihexylamine, diisobutylamine, di-t-butylamine, dineopentylamine, di-t-pentylamine, dicyclopentylamine, dicyclohexylamine, and the like. Secondary amines outside the C₄-C₁₂ range can also be used, but such secondary amines can have undesirable physical properties such as low boiling points or waxy consistencies that can complicate their handling.

In some embodiments, the surfactant system can include a chelating agent, particularly a diamine chelating agent. In some embodiments, one or both of the nitrogen atoms of the diamine chelating agent can be substituted with one or two alkyl groups. When two alkyl groups are present on the same nitrogen atom, they can be the same or different. Further, when both nitrogen atoms are substituted, the same or different alkyl groups can be present. In some embodiments, the alkyl groups can be C₁-C₆ alkyl groups. In other embodiments, the alkyl groups can be C₁-C₄ alkyl groups or C₃-C₆ alkyl groups. In some embodiments, C₃ or higher alkyl groups can be straight or have branched chains. In some embodiments, C₃ or higher alkyl groups can be cyclic. Without being bound by any theory or mechanism, it is believed that diamine chelating agents can facilitate metal nanoparticle formation by promoting nanoparticle nucleation.

In some embodiments, suitable diamine chelating agents can include N,N′-dialkylethylenediamines, particularly C₁-C₄ N,N′-dialkylethylenediamines. The corresponding methylenediamine, propylenediamine, butylenediamine, pentylenediamine or hexylenediamine derivatives can also be used. The alkyl groups can be the same or different. C₁-C₄ alkyl groups that can be present include, for example, methyl, ethyl, propyl, and butyl groups, or branched alkyl groups such as isopropyl, isobutyl, s-butyl, and t-butyl groups. Illustrative N,N′-dialkylethylenediamines that can be suitable for inclusion upon metal nanoparticles include, for example, N,N′-di-t-butylethylenediamine, N,N′-diisopropylethylenediamine, and the like.

In some embodiments, suitable diamine chelating agents can include N,N,N′,N′-tetraalkylethylenediamines, particularly C₁-C₄ N,N,N′,N′-tetraalkylethylenediamines. The corresponding methylenediamine, propylenediamine, butylenediamine, pentylenediamine or hexylenediamine derivatives can also be used. The alkyl groups can again be the same or different and include those mentioned above. Illustrative N,N,N′,N′-tetraalkylethylenediamines that can be suitable for use in forming metal nanoparticles include, for example, N,N,N′,N′-tetramethylethylenediamine, N,N,N′,N′-tetraethylethylenediamine, and the like.

Surfactants other than aliphatic amines can also be present in the surfactant system. In this regard, suitable surfactants can include, for example, pyridines, aromatic amines, phosphines, thiols, or any combination thereof. These surfactants can be used in combination with an aliphatic amine, including those described above, or they can be used in a surfactant system in which an aliphatic amine is not present. Further disclosure regarding suitable pyridines, aromatic amines, phosphines, and thiols follows below.

Suitable aromatic amines can have a formula of ArNR¹R², where Ar is a substituted or unsubstituted aryl group and R¹ and R² are the same or different. R¹ and R² can be independently selected from H or an alkyl or aryl group containing from 1 to about 16 carbon atoms. Illustrative aromatic amines that can be suitable for use in forming metal nanoparticles include, for example, aniline, toluidine, anisidine, N,N-dimethylaniline, N,N-diethylaniline, and the like. Other aromatic amines that can be used in conjunction with metal nanoparticles can be envisioned by one having ordinary skill in the art.

Suitable pyridines can include both pyridine and its derivatives. Illustrative pyridines that can be suitable for inclusion upon metal nanoparticles include, for example, pyridine, 2-methylpyridine, 2,6-dimethylpyridine, collidine, pyridazine, and the like. Chelating pyridines such as bipyridyl chelating agents may also be used. Other pyridines that can be used in conjunction with metal nanoparticles can be envisioned by one having ordinary skill in the art.

Suitable phosphines can have a formula of PR₃, where R is an alkyl or aryl group containing from 1 to about 16 carbon atoms. The alkyl or aryl groups attached to the phosphorus center can be the same or different. Illustrative phosphines that can be present upon metal nanoparticles include, for example, trimethylphosphine, triethylphosphine, tributylphosphine, tri-t-butylphosphine, trioctylphosphine, triphenylphosphine, and the like. Phosphine oxides can also be used in a like manner. In some embodiments, surfactants that contain two or more phosphine groups configured for forming a chelate ring can also be used. Illustrative chelating phosphines can include 1,2-bisphosphines, 1,3-bisphosphines, and bis-phosphines such as BINAP, for example. Other phosphines that can be used in conjunction with metal nanoparticles can be envisioned by one having ordinary skill in the art.

Suitable thiols can have a formula of RSH, where R is an alkyl or aryl group having from about 4 to about 16 carbon atoms. Illustrative thiols that can be present upon metal nanoparticles include, for example, butanethiol, 2-methyl-2-propanethiol, hexanethiol, octanethiol, benzenethiol, and the like. In some embodiments, surfactants that contain two or more thiol groups configured for forming a chelate ring can also be used. Illustrative chelating thiols can include, for example, 1,2-dithiols (e.g., 1,2-ethanethiol) and 1,3-dithiols (e.g., 1,3-propanethiol). Other thiols that can be used in conjunction with metal nanoparticles can be envisioned by one having ordinary skill in the art.

As mentioned above, a distinguishing feature of metal nanoparticles is their high surface energy, particularly after removal of a surfactant coating therefrom, which may promote adherence to touch surfaces, masks or other PPE in need of disinfection or infection control. Robust surface adherence may still be realized with an intact surfactant coating, however, particularly when an adhesive is used to promote adherence of metal nanoparticle agglomerates to a surface. According to the disclosure herein, metal nanoparticle agglomerates, such as agglomerates of silver nanoparticles and/or copper nanoparticles, as well as zinc nanoparticles, nickel nanoparticles, titanium nanoparticles or their oxides, optionally in combination with silver nanoparticles and/or copper nanoparticles or their oxides, may be disposed in a spray formulation suitable for deposition upon a surface, such as PPE or a touch surface. In particular, such spray formulations may comprise an aerosolizable fluid medium, and a plurality of metal nanoparticle agglomerates dispersed in the fluid medium. A surfactant associated with the metal nanoparticles may further facilitate dispersion in the aerosolizable fluid medium and promote surface adherence following deposition on a surface. An adhesive may also be present in the spray formulations and further promote surface adherence, particularly prior to surfactant loss and formation of uncoated metal nanoparticles having a high surface energy.

As-produced metal nanoparticles are usually produced in the form of agglomerates which need to be broken apart into smaller agglomerates and/or individual surfactant-coated metal nanoparticles in order to promote use in various applications. Surprisingly, in the disclosure herein, the as-produced agglomerates, such as those residing in a 0.1-35 micron size range, particularly a 1-15 micron size range, a 0.5-5 micron size range, or a 1-5 micron size range, can be effective for spray dispensation and retention upon a surface. Agglomerates of these sizes, and even larger, may be more effectively retained upon a surface than can individual metal nanoparticles or smaller agglomerates. Such agglomerates may change their shape as they adhere to a surface, while remaining bound to each other in a “colony.” Within the agglomerates, recognizable sub-structures may be present prior to nanoparticle fusion such as, but not limited to, 10-50 nm thick platelets having a width of about 100-250 nm, 1-5 nm thick platelets having a width of about 30-50 nm, 100-250 nm wide spheres, metal nanowires, the like, or any combination thereof. The sub-structures may have any shape such as square, triangular, rectangular, multi-faceted, round, and ovular, and crystalline, and/or non-crystalline morphologies. Elongate structures, such as metal nanowires, may have an aspect ratio of at least about 10 or at least about 25, for example. Copper nanoparticles and/or silver nanoparticles may also be combined with pre-made nanowires (e.g., copper nanowires or silver nanowires) and deposited upon a surface as well. Zinc, nickel, or titanium, particularly in the form of nanoparticles or a metal oxide form thereof, may be present in any of these embodiments as well.

Spray formulations of the present disclosure may comprise an aerosolizable fluid medium, and a plurality of metal nanoparticle agglomerates thereof dispersed in the aerosolizable fluid medium. The aerosolizable fluid medium may be an aerosol propellant (optionally including an organic solvent) or a volatile organic solvent, depending on whether the spray formulations will be sprayed via pumping or gas-pressurization, or dispensed from an aerosol spray vessel, such as an aerosol spray can. Aerosol spray cans may be particularly desirable, since they are in wide use and are easily manufactured and shipped. Thus, aerosol spray formulations containing metal nanoparticle agglomerates may be particularly advantageous.

Spray formulations comprising metal nanoparticle agglomerates, such as silver nanoparticles and/or copper nanoparticles and their agglomerates, may be prepared by dispersing as-produced or as-isolated metal nanoparticles in an organic matrix containing one or more organic solvents or other liquid medium in which the metal nanoparticle agglomerates may be admixed as a well-dispersed solid. Optionally, the aerosolizable fluid medium may comprise one or more inorganic components as well, particularly water. Spray formulations refer to both mechanically pumped and forced sprays and sprays dispensed through use of an aerosol propellant. Pumped and forced sprays may be dispensed through gas pressurization, and/or through pressurization with a mechanical or pneumatic pump. An aerosol propellant may be present in a vessel housing an organic matrix containing dispersed metal nanoparticle agglomerates for spray formulations not intended for dispensation via pumping or gas pressurization. Spray formulations containing an aerosol propellant may be stored in a pressurized state, such that the spray formulation may dispensed simply by activating a release upon a vessel housing the spray formulation.

Particularly suitable organic solvents that may be present in spray formulations suitable for dispensation by pumping or pressurization, or in combination with an aerosol propellant, include one or more alcohols and optionally water. Suitable alcohols include a C₁-C₁₁ alcohol, or multiple C₁-C₁₁ alcohols in any combination. Additional alcohol-miscible organic solvents may also be present. Ketone and aldehyde organic solvents, also in the C₁-C₁₁ size range, may also be used, either alone or in combination with one or more alcohols. Ketone and aldehyde solvents are less polar than are alcohols and may aid in promoting dispersion of metal nanoparticle agglomerates. Low boiling ethers such as diethyl ether, dipropyl ether, and diisopropyl ether, for example, may also be suitably used to promote metal nanoparticle dispersion. One or more glycol ethers (e.g., diethylene glycol, triethylene glycol, or the like), alkanolamines (e.g., ethanolamine, triethanolamine, or the like), or any combination thereof may also be used alone or in combination with one or more alcohols or any of the other foregoing organic solvents. Various glymes may also be used similarly. Water-miscible organic solvents and mixtures of water and water-miscible organic solvents may be used as well, such as water-organic solvent mixtures comprising up to about 50% water by volume, or up to about 75% water by volume, or up to about 90% water by volume. The organic solvent(s) may be removed either before or after the surfactant coating is lost in the course of promoting adherence of the metal nanoparticles to a surface.

In particular examples, the spray formulations can contain one or more alcohols, which may be C₁-C₁₁, C₁-C₄, C₄-C₁₁ or C₇-C₁₁ in more particular embodiments. C₁-C₄ alcohols may be particularly desirable due to their lower boiling points, which may facilitate solvent removal following dispensation. In various embodiments, the alcohols can include any of monohydric alcohols, diols, or triols. One or more glycol ethers (e.g., diethylene glycol and triethylene glycol), alkanolamines (e.g., ethanolamine, triethanolamine, and the like), or any combination thereof may be present in certain embodiments, which may be present alone or in combination with other alcohols. Various glymes may be present with the one or more alcohols in some embodiments.

Spray formulations suitable for dispensation by pumping or forced pressurization with a gas may exhibit a viscosity value of about 1 cP to about 500 cP, including about 1 cP to about 100 cP. Low viscosity values such as these may facilitate dispensation through spraying promoted by mechanical pumping or forced pressurization. Metal nanoparticle loadings within the spray formulations to produce the foregoing viscosity values may range from about 1 wt. % to about 35 wt. %, or about 5 wt. % to about 35 wt. %, or about 10 wt. % to about 25 wt. %, or about 8 wt. % to about 25 wt. %, or about 1 wt. % to about 8 wt. %.

Spray formulations comprising an aerosol propellant may also be suitable for use in the disclosure herein. Such spray formulations may similarly comprise metal nanoparticles or agglomerates thereof dispersed in a fluid medium comprising at least an aerosol propellant and optionally other solvents to promote metal nanoparticle dispersion therein. Aerosol propellants may afford sprayed droplets ranging from about 10-150 microns in size, whereas mechanically pumped or forced-pressurization sprays may have a larger droplet size in a range of about 150-400 microns.

Any conventional aerosol propellant may be utilized in the spray formulations disclosed herein, provided that the metal nanoparticle agglomerates can be effectively dispersed therein, optionally in combination with one or more additional solvents, and ejected from a spray can or similar pressure vessel. Organic and/or inorganic aerosol propellants may be used. Suitable inorganic aerosol propellants may include, for example, nitrous oxide or carbon dioxide. Suitable organic aerosol propellants may include, for example, volatile hydrocarbons (e.g., ethane, propane, butane, or isobutane), dimethyl ether, ethyl methyl ether, hydrofluorocarbons, hydrofluoroolefins, or any combination thereof. Chlorofluorocarbons and similar compounds may also be used as an aerosol propellant, but their use is not preferred due to their ozone-depleting properties. Nevertheless, chlorofluorocarbons may be satisfactory alternatives in situations where other organic aerosolizable fluid media may not be effectively used.

When using an aerosol propellant to promote dispensation of metal nanoparticle agglomerates, the metal nanoparticle agglomerates may be directly combined therewith, or the metal nanoparticles may be dissolved in a secondary fluid medium that is subsequently combined with the aerosol propellant in a spray can or similar pressure vessel. Suitable secondary fluid media may comprise organic solvents such as alcohols, glycols, ethers, or the like. Any of the organic solvents utilized above in mechanically pumped or forced-pressurization spray formulations may be incorporated in spray formulations containing an aerosol propellant as a secondary fluid medium as well.

Spray formulations comprising an organic solvent may comprise a mixture of organic solvents that evaporates in a specified period of time, typically under ambient conditions. In non-limiting examples, evaporation may take place in about 1 minute or less, or about 2 minutes or less, or about 5 minutes or less, or about 10 minutes or less, or about 15 minutes or less, or about 30 minutes or less. To facilitate evaporation, the metal nanoparticles may be dispersed as a concentrate in a higher boiling organic solvent, such as a Cio alcohol, which is then combined with a much larger quantity of low boiling organic solvent, such as ethanol or diethyl ether, optionally in further combination with additional organic solvents. The high boiling organic solvent may be sufficiently hydrophobic to facilitate dispersion of the metal nanoparticles in the less hydrophobic and lower boiling organic solvent comprising the majority of the organic phase. Since the high boiling organic solvent is present in only small quantities, it does not adversely impact the evaporation time to a significant degree.

Spray formulations containing an aerosol propellant may be loaded in a spray vessel comprising a body, a valve and an actuator for the valve. Suitable spray vessels include, for example, disposable spray cans and similar pressure vessels, which will be familiar to persons having ordinary skill in the art.

Spray formulations dispersed in one or more organic solvents but lacking an aerosol propellant may be loaded in a spray vessel featuring a pump and/or a gas pressurization line for ejecting the spray formulation via a suitably configured outlet to promote droplet formation. Suitable spray vessels may be manually pumped, pressurized with a gas (e.g., an inert gas) or air, or coupled to a mechanical or pneumatic pump.

The metal nanoparticles used in the spray formulations disclosed herein may be about 20 nm or more in size, more particularly about 50 nm or more in size. In particularly suitable examples, all or at least about 90%, at least about 95%, or at least about 99% of the metal nanoparticles within the metal nanoparticle agglomerates may be about 20 nm to about 200 nm in size or about 50 nm to about 250 nm in size. Smaller copper nanoparticles (under 20 nm) may tend to undergo more extensive oxidation than do larger metal nanoparticles, and such metal nanoparticles may be present to support a desired extent of oxidation. For example, smaller copper nanoparticles may tend to undergo more extensive oxidation into CuO or Cu₂O, including partial or complete oxidation into these compounds, than do larger copper nanoparticles having a size above 20 nm. Copper nanoparticles in the foregoing size range (20 nm or above, or about 50 nm or above) may afford a coating comprising a mixture of CuO and Cu₂O, or a salt compound, upon a metallic copper metal core, the combination of which may be advantageous for promoting disinfection according to the disclosure herein. Silver nanoparticles in a similar size range may form a coating comprising silver oxide upon a metallic silver core. When copper nanoparticles and/or silver nanoparticles are agglomerated together upon a surface, the oxide coating may extend over at least a portion of the surface of the agglomerate, leaving an exposed copper or silver metal surface below within the porosity of the agglomerate. The oxide(s) in combination with unconverted metal may offer complementary biocidal activity for promoting disinfection according to the disclosure herein. By having larger metal nanoparticles in the foregoing size range, a substantial amount of zero-valent metal may be retained for promoting biocidal activity in combination with at least some oxide, whereas smaller metal nanoparticles may form too much oxide to promote optimal biocidal activity.

Metal nanoparticle agglomerate loadings upon a surface may range from about 0.5 wt. % to about 5 wt. % based on total weight. The loading of metal nanoparticle agglomerates upon a surface through deposition of a spray formulation may include a coverage density ranging from about 0.1 mg/in² to about 10 mg/in², or about 0.5 mg/in² to about 5 mg/in², or about 1 mg/in² to about 2 mg/in² or about 0.5 mg/in² to about 3 mg/in², or about 0.4 mg/in² to about 5 mg/in². To achieve loadings in the above range, the coverage of metal nanoparticle agglomerates upon the surface may range from about 5% to about 95% by area, or about 50% to about 99% by area, or about 60% to 95% by area. Areal coverage may refer to the extent of coverage upon individual fibers of a fibrous base substrate or upon a base substrate as a whole. Even coverage densities as low as 3-5% by area may be effective for biocidal activity in the disclosure herein due to the mobility of individual metal nanoparticles or small metal nanoparticle agglomerates shed from adhered, larger metal nanoparticle agglomerates. When present at the foregoing coverages and coverage densities, the metal nanoparticles released from the metal nanoparticle agglomerates may effectively inactivate various pathogens, including certain bacteria and viruses, oftentimes more effectively than does a bulk metal surface comprising the same metal. For example, copper nanoparticles adhered to a surface and retaining their nanoparticulate form within a plurality of nanoparticle agglomerates may inactivate/kill viruses in as little as 5-10 seconds. Even dry wipes containing metal nanoparticle agglomerates may be effective for inactivating viruses within this timeframe. Up to 100% kill rates or inactivation rates may be realized in such a short time. Bulk copper surfaces, in contrast, may take several hours to reach the same level of inactivation. Bacteria may undergo similar levels of inactivation or killing in various instances.

Copper nanoparticles that are about 20 nm or less in size can also be used in the spray formulations disclosed herein. Copper nanoparticles in this size range have a fusion temperature of about 220° C. or below (e.g., a fusion temperature in the range of about 140° C. to about 220° C.) or about 200° C. or below, or even about 175° C. or below, which can provide certain advantages noted above. Silver nanoparticles about 20 nm or less in size may also be used in the spray formulations disclosed herein and similarly exhibit a fusion temperature differing significantly from that of the corresponding bulk metal.

Larger metal nanoparticles (either copper or silver nanoparticles), in turn, have a higher fusion temperature, which may rapidly increase and approach that of bulk metal as the nanoparticle size continues to increase. Depending on the processing temperature and the fusion temperature of the copper nanoparticles and/or silver nanoparticles based upon their size, the metal nanoparticles may or may not be fused upon a surface when sprayed thereon according to the disclosure herein. Regardless of whether the nanoparticles become fused or not once deposited upon a surface, after the surfactant coating has been removed, the copper nanoparticles and/or silver nanoparticles may experience robust adherence to the surface and become effective for inactivating various pathogens. Surface oxidation of the metal nanoparticles may take place during this process, as discussed above.

As-produced copper nanoparticles and silver nanoparticles are usually produced in the form of agglomerates that need to be broken apart into individual surfactant-coated metal nanoparticles in order to promote use in various applications. Surprisingly, in the disclosure herein, the as-produced agglomerates, such as those residing in a 0.5-5 micron size range (500 nm-5 micron size range), can be effective for spray dispensation and retention upon a surface. Agglomerates of these sizes, and even larger, may be more effectively retained upon a surface than are individual metal nanoparticles or smaller agglomerates. Within the agglomerates, recognizable sub-structures may be present prior to nanoparticle fusion such as, but not limited to, 10-50 nm thick platelets, 100-250 nm wide spheres, metal nanowires, the like, or any combination thereof. Copper nanoparticles and/or silver nanoparticles may also be combined with pre-made nanowires (e.g., copper nanowires or silver nanowires) in a suitable spray formulation for deposition upon a surface as well.

In addition to metal nanoparticle agglomerates or alternative nanostructures, other additives may be incorporated within spray formulations suitable for use in the disclosure herein. Suitable additives may include, but are not limited to, those capable of producing reactive oxygen species (ROS), which may cause lipid, protein, or DNA damage in microorganisms, eventually leading to cell membrane damage and cell death. These additives may complement or enhance the biocidal activity conveyed by copper nanoparticles, silver nanoparticles, or alternative metal nanoparticles having biocidal activity, such as those comprising zinc, nickel, titanium, and/or their oxide forms. Conventional disinfectant compounds and/or conventional biocides may be included in the spray formulations as well, examples of which will be familiar to one having ordinary skill in the art.

NiO may be included as an additive within the spray formulations of the present disclosure. NiO is very efficient in producing ROS when present in small concentrations. NiO may be effective when included at, for example, about 0.5% to about 10% of the load of copper nanoparticles and/or silver nanoparticles in the spray formulations (e.g., 0.5 mg to 100 mg NiO), particularly as sub-micron particles separate and distinct from the copper nanoparticles and/or silver nanoparticles. At these loadings, NiO is very effective against certain bacteria, which may broaden the biocidal effectiveness of copper or silver. Bismuth, zinc, and tin oxides may be similarly effective at loadings of about 0.5% to about 10% of the mass of copper nanoparticles and/or silver nanoparticles.

TiO₂ may be included within spray formulations of the present disclosure. TiO₂ may catalyze the formation of hydroxyl radicals upon UV irradiation (e.g., in sunlight) when a nanoparticle-coated surface is taken outdoors or otherwise exposed to electromagnetic radiation capable of activating the TiO₂. Moisture from a wearer's breath or atmospheric moisture may supply the source of water for producing the hydroxyl radicals by photooxidation. TiO₂ may be present at about 1% to about 25% of the load of copper nanoparticles and/or silver nanoparticles in the spray formulations. The TiO₂ may likewise be present in the form of nanoparticles and/or micron-size particles (e.g., about 100 nm to about 5 microns).

Copper nanoparticles and/or silver nanoparticles, ZnO, NiO and/or TiO₂ may also be used in combination with one another as well. These additives may be sprayed upon the filtration medium at the same time as agglomerates of copper nanoparticles and/or silver nanoparticles (from the same spray formulation or different spray formulations), or may be sprayed before or after the copper nanoparticles and/or silver nanoparticles.

After depositing a spray formulation upon a surface, removal of the solvent and optionally surfactants may take place. Although solvents and surfactants may be removed under ambient conditions (room temperature and atmospheric pressure), application of at least one of heating, gas flow, and/or vacuum (reduced pressure) may accelerate removal of the solvent and surfactants, thereby leading to the metal nanoparticle agglomerates becoming adhered to the surface. Heating may take place at any temperature up to or beyond the fusion temperature of the metal nanoparticles, provided that the heating temperature is not so high that the surface itself experiences thermal damage. Thus, the metal nanoparticles within the metal nanoparticle agglomerates may be fused or unfused when adhered to the surface. Moreover, the heating temperature need not necessarily exceed the normal boiling point or reduced pressure boiling point of the surfactants and solvents in order to promote their removal. Gentle heating well below the boiling point of the surfactant and solvent may be sufficient to promote their removal in many instances. In non-limiting embodiments, the heating may be conducted under flowing nitrogen, air or other inert gas or under vacuum to promote removal. For example, heating at a temperature of about 35° C. to about 65° C. in flowing nitrogen or air may be sufficient to remove the solvent and surfactant, thereby leaving unfused metal nanoparticles adhered to a surface as a plurality of metal nanoparticle agglomerates. Additional heating may be conducted thereafter, if desired, to promote metal nanoparticle fusion. When heating under higher temperatures, use of an inert atmosphere, such as nitrogen, may be desirable to limit degradation of the surface and to control the amount of surface oxidation taking place upon the metal nanoparticles once the surfactant coating has been removed therefrom.

Once the surfactant coating has been removed from the metal nanoparticles, particularly copper nanoparticles and/or silver nanoparticles, the metal nanoparticles and/or agglomerates thereof may undergo at least partial oxidation. As indicated above, in the case of copper nanoparticles, the size of the copper nanoparticles and the agglomerates thereof may be selected such that at least some copper metal remains following oxidation, since a mixture of copper metal (metallic copper) and oxidized copper may be beneficial for promoting pathogen inhibition or killing. Silver nanoparticles may similarly experience different amounts of surface oxidation depending upon the size of the silver nanoparticles and how they are processed. In non-limiting embodiments, following surfactant removal, copper nanoparticles may form a reaction product comprising about 25% to about 99% metallic copper by weight or about 45% to about 90% metallic copper by weight, about 0.5% to about 60% Cu₂O by weight, and about 0.1% to about 80% CuO by weight or about 0.1% to about 20% CuO by weight. In more particular embodiments, the amount of metallic copper may be about 45% to about 90% by weight, or about 50% to about 70% by weight, and the amount of Cu₂O may be about 10% by weight or less, such as about 0.1% to about 10% by weight or less or about 5% to about 10% by weight or less, and the amount of CuO may be about 1% by weight or less, such as about 0.1% to about 1% by weight or about 0.5% to about 1% by weight. The Cu₂O and CuO may form a coating (shell) upon the metal nanoparticles or agglomerates thereof that is about 10 nm or greater in thickness, or 100 nm or greater in thickness, such as about 100 nm to about 3 microns thick in many instances.

Silver nanoparticles upon a surface may similarly comprise about 25% to about 99% metallic silver by weight and the balance being Ag₂O after undergoing oxidation. The Ag₂O may similarly be present in a coating (shell) having a thickness of about 10 nm or greater, such as about 100 nm to about 3 microns thick.

As discussed above, metal nanoparticles may exhibit adherence to a variety of surfaces, such as through van der Waals adhesion and electrostatic interactions, which may be further supplemented through the high surface energy of the metal nanoparticles. In addition to metal nanoparticle agglomerates, the spray formulations disclosed herein may further comprise an adhesive that is suitable for promoting metal nanoparticle adherence to a given surface. Suitable adhesives will be familiar to one having ordinary skill in the art and include conventional epoxy adhesives, nitrile rubber adhesives, acrylic adhesives, styrene-acrylic adhesives, cyanoacrylate adhesives, solvent-based adhesives, aqueous emulsions, and the like. Particularly suitable adhesive may be biologically compatible adhesives such as octyl cyanoacrylate, 2-octyl cyanoacrylate, butyl cyanoacrylate, and isobutyl cyanoacrylate. Other examples of suitable adhesives having biocompatibility include, for example, polydioxanone, polyglycolic acid, polylactic acid, and polyglyconate. MAXON, a polyglycolide-trimethylene carbonate used a biodegradable suture adhesive, may represent a particular example. The adhesive may be present in the spray formulations in an amount sufficient to promote uniform application upon a surface, such as at a loading of 0.5 mg/in² to about 5 mg/in² or 0.1 mg/in² to about 0.5 mg/in². Suitable loadings of the adhesive in the spray formulations may range from about 0.35 g adhesive/100 g spray formulation to about 2.75 g adhesive/100 g spray formulation. Coverage of the adhesive upon a surface following application of the spray formulations may range from about 50% to about 100% by area, or about 60% to about 90% by area, or about 75% to about 95% by area, or about 90% to about 99% by area. A layer thickness of the adhesive layer upon the surface may be about 300 nm or less, such as about 1 nm to about 2 nm, or about 2 nm to about 5 nm, or about 5 nm to about 10 nm, or about 10 nm to about 50 nm, or about 10 nm to about 300 nm. In addition to promoting surface adherence, the adhesive may slow down the production of oxidized metal species, thereby affording further tailoring of the time-release profile of individual or small agglomerates of metal nanoparticles or various oxidized forms thereof. An additional disinfection operation, such as exposure to ultraviolet light, may also be used in combination with deposition of metal nanoparticles upon a surface in need of disinfection.

When applying an adhesive to a surface, the adhesive may be present in the spray formulation in combination with the metal nanoparticle agglomerates, or an adhesive formulation may be applied separately (e.g., by spraying) from a spray formulation comprising metal nanoparticle agglomerates. The adhesive formulation may be applied to the surface before applying the spray formulation comprising metal nanoparticle agglomerates or afterward. In non-limiting examples, an adhesive formulation may also be sprayed upon a surface upon which metal nanoparticle agglomerates are being applied.

Methods for disinfecting a surface may comprise providing a surface in need of disinfection, and applying a spray formulation on the surface, in accordance with the disclosure above. In particular, the spray formulation may comprise a plurality of metal nanoparticle agglomerates dispersed in an aerosolizable fluid medium, optionally comprising an aerosol propellant and/or an adhesive. The surface may comprise a surface present in a mask or other PPE, or may be a touch surface already deployed in its native environment. The surface may have already been disinfected with metal nanoparticles or another disinfection method, or the surface may not have been previously disinfected. In addition, the surface may have been previously impregnated with metal nanoparticles during manufacturing. De novo application of metal nanoparticles agglomerates according to the disclosure herein may aid in regenerating antiseptic activity of the surface, regardless of how the surface was previously disinfected. Surface disinfection according to the disclosure herein may be conducted any number of times until a mask, PPE or other surface simply wears out or is otherwise no longer useful, such as 2, 3, 4, 5, 6, 7, 8, 9 or 10 times, or even more times. Following application of metal nanoparticles agglomerates with a suitable spray formulation, masks and other touch surfaces may be reusable/have antiseptic activity conveyed thereto for at least one day (8-12 hours), or at least about 2 days, or at least about 3 days, or at least about 4 days, or at least about 5 days, or at least about 6 days, or at least about 7 days, or at least about 10 days, or at least about 14 days, or at least about 21 days, or at least about 30 days. An even longer post-application shelf life of about 6 months may be realized by storing a mask in a sealed bag.

Materials with masks and PPE that may be suitably disinfected through use of the disclosure herein are not considered to be particularly limited. Illustrative materials within masks and PPE that may be disinfected through the disclosure herein include, for example, natural or synthetic fibers such as cellulosic, cotton or polymer fibers, for example. Suitable polymer fibers may include, but are not limited to, polyester, polypropylene, polystyrene, or any combination thereof. Masks having media rated N95, N99, or even N100 may be effectively disinfected through use of the disclosure herein. Surgical masks may also be effectively disinfected through use of the disclosure herein. Replaceable filter cartridges for alternative types of masks may also be disinfected through use of the disclosure herein.

Masks suitable for disinfection according to the disclosure herein may comprise a dome shape suitable for snug fitting around the face, mouth and nose of a wearer. The mask may have an overall area of about 28-30 square inches or about 28-36 square inches. Suitable masks may be single-layered or comprise multiple layers of filtration media that are bonded together at the edges. An adhesive may be included to bond the layers together and/or to facilitate adherence of the copper nanoparticles and/or silver nanoparticles to the filtration medium.

Embodiments disclosed herein include:

A. Spray formulations comprising metal nanoparticles. The spray formulations comprise: an aerosolizable fluid medium; and

a plurality of metal nanoparticles dispersed in the fluid medium.

A1. A touch surface having the spray formulation of A.

A2. Personal protective equipment having the spray formulation of A.

A3. An aerosol spray can comprising the spray formulation of A.

B. Methods for disinfecting a surface. The methods comprise: providing a surface in need of disinfection; and

applying a spray formulation on the surface, the spray formulation comprising an aerosolizable fluid medium and a plurality of metal nanoparticles dispersed in the fluid medium.

Each of embodiments A and B may have one or more of the following additional elements in any combination:

Element 1: wherein the plurality of metal nanoparticles comprises copper nanoparticles, silver nanoparticles, agglomerates thereof, or any combination thereof.

Element 2: wherein the metal nanoparticles range in size from about 20 nm to about 150 nm.

Element 3: wherein the metal nanoparticles are aggregated as a plurality of metal nanoparticle agglomerates having a size ranging from about 500 nm to about 5 microns.

Element 4: wherein the aerosolizable fluid medium comprises one or more alcohols and optionally water.

Element 5: wherein the aerosolizable fluid medium comprises an aerosol propellant.

Element 6: wherein the spray formulation is applied to the surface by pumping.

Element 7: wherein the spray formulation is applied to the surface by dispensation from an aerosol spray can.

By way of non-limiting example, exemplary combinations applicable to A, A1, A2, A3, and B include: 1 and 2; 1 and 3; 1 and 4; 1 and 5; 1, 4 and 5; 2 and 3; 2 and 4; 2, 4 and 5; 3 and 4; 3-5; and 4 and 5. Any one of the foregoing may be in further combination with 6 or 7. Further non-limiting exemplary combinations applicable to A and B include 1, and 6 or 7; 2, and 6 or 7; 3, and 6 or 7; 4, and 6 or 7; 5, and 6 or 7; and 4 and 5, and 6 or 7.

Additional embodiments disclosed herein include:

AA. Spray formulations. The spray formulations comprise: an aerosolizable fluid medium; and a plurality of metal nanoparticle agglomerates dispersed in the aerosolizable fluid medium.

AA1. Personal protective equipment having the spray formulation of AA deposited thereon.

AA2. Touch surfaces having the spray formulation of AA deposited thereon.

AA3. Aerosol spray cans loaded with the spray formulation of AA.

BB. Methods for disinfecting a surface. The methods comprise: providing a surface in need of disinfection; and applying a spray formulation on the surface, the spray formulation comprising an aerosolizable fluid medium and a plurality of metal nanoparticle agglomerates dispersed in the aerosolizable fluid medium.

Each of embodiments AA, AA1, AA2, AA3 and BB may have one or more of the following additional elements in any combination:

Element 1′: wherein metal nanoparticles within the metal nanoparticle agglomerates comprise copper nanoparticles, silver nanoparticles, or any combination thereof.

Element 2′: wherein the spray formulation further comprises NiO, ZnO, TiO₂ or any combination thereof.

Element 3′: wherein the metal nanoparticle agglomerates comprise copper nanoparticles, and the copper nanoparticles comprise metallic copper and a coating comprising Cu₂O, CuO or any combination thereof.

Element 4′: wherein the metal nanoparticle agglomerates comprise metal nanoparticles, in which at least a majority of the metal nanoparticles range from about 50 nm to about 250 nm in size.

Element 5′: wherein the metal nanoparticle agglomerates range from about 500 nm to about 35 microns in size.

Element 6′: wherein the aerosolizable fluid medium comprises one or more alcohols and optionally water.

Element 7′: wherein the aerosolizable fluid medium comprises an aerosol propellant.

Element 8′: wherein the spray formulation further comprises an adhesive.

Element 9′: wherein the spray formulation is applied to the surface by pumping or gas pressurization.

Element 10′: wherein the spray formulation is applied to the surface by dispensation from an aerosol spray can.

By way of non-limiting example, illustrative combinations applicable to AA, AA1, AA2, AA3 and BB include, but are not limited to, 1′ and 2′; 1′ and 3′; 1′ and 4′; 1′ and 5′; 1′ and 6′; 1′, 6′ and 7′; 1′ and 8′; 3′ and 4′; 3′ and 5′; 3′ and 6′; 3′, 5′ and 6′; 3′, 5′, 6′ and 7′; 3′, 6′ and 7′; 3′ and 7′; 3′ and 8′; 4′ and 5′; 4′ and 6′; 4′-6′; 4′-7′; 4′ and 7′; 4′; 5′ and 7′; 4′ and 8′; 5′ and 6′; 5′-7′; 5′ and 8′; 6′ and 7′; 6′ and 8′; 7′ and 8′; 1′ and 9′; 3′ and 9′; 4′ and 9′; 5′ and 9′; 6′ and 9′; 7′ and 9′; 8′ and 9′; 9′ and 10′; 1′ and 10′; 3′ and 10′; 4′ and 10′; 5′ and 10′; 6′ and 10′; 7′ and 10′; and 8′ and 10.

To facilitate a better understanding of the present disclosure, the following examples of preferred or representative embodiments are given. In no way should the following examples be read to limit, or to define, the scope of the invention.

### EXAMPLES

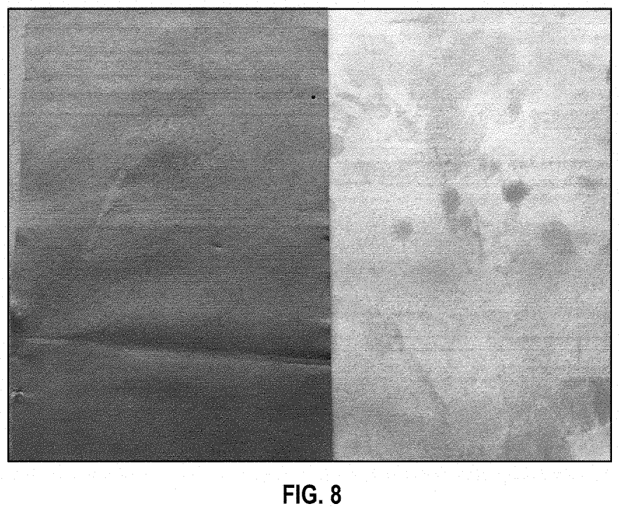

Agglomerates of copper nanoparticles in the 50-250 nm size range with a monolayer of amine surfactants on their surfaces and having an agglomerate size of 1-35 microns were adhered to a 55/45 cellulose/polyester fabric blend with an average fiber diameter of about 10 microns using an epoxy adhesive. This may be done via spray coating onto the fibers. The adhesive layer was about 20-50 nm thick, and the metal nanoparticle agglomerates were partially embedded in the adhesive layer with a substantial portion still exposed. The areal coverage of the agglomerates upon the fiber surfaces was about 20-50%. The copper loading upon the fabric ranged from about 1.2 mg/in² to about 2.7 mg/in². Depending on size, some of the agglomerates may have the surfactant layer partially removed, thereby resulting in partial oxidation and an overall mixture of copper metal, Cu₂O and CuO species on the fiber surface. The copper metal to oxide ratio may reside in the 1-10% range. Over time, oxidation and dissolution progressively result in fading of the initial dark brown-red color to more light yellow-green. FIG. 8 shows an illustrative photographic image of a fabric having agglomerates of copper nanoparticles adhered thereto, as fabricated (left side of image) and after extended use (right side of image).

The nanoparticle-loaded fabric was then subjected to various stability and toxicological tests specified below.

Agglomerates of copper nanoparticles in the 20-150 nm size range with a partially removed monolayer of amine surfactants on their surfaces and having an agglomerate size of 5-15 microns were adhered to a 30/70 cellulose/polyester fabric blend with an average fiber diameter of about 10 microns using an epoxy adhesive. This may be done via spray coating onto the fibers. The adhesive layer was about 50-100 nm thick and the metal nanoparticle agglomerates were partially embedded in the adhesive layer with a substantial portion still exposed. The areal coverage of the agglomerates upon the fiber surfaces is about 30-70%. The copper loading upon the fabric ranged from about 2.3 mg/in² to about 4.5 mg/in². Depending on size, some of the agglomerates may be fully or partially oxidized, thereby resulting in an overall mixture of copper metal, Cu₂O and CuO species on the fiber surface. The copper metal to oxide ratio may reside in the 5-25% range.

Agglomerates of copper nanoparticles in the 50-250 nm size range with a monolayer of amine surfactants on their surfaces and having an agglomerate size of 1-35 microns were adhered to a 55/45 cellulose/polyester fabric blend with an average fiber diameter of about 10 microns using a styrene acrylic acid block copolymer adhesive. This may be done via spray onto the fibers. The adhesive layer was about 100-250 nm thick, and the metal nanoparticle agglomerates were partially embedded in the adhesive layer with a substantial portion still exposed. The areal coverage of the agglomerates upon the fiber surfaces is about 10-35%. The copper loading upon the fabric ranged from about 1.7 mg/in² to about 3.5 mg/in². Depending on size, some of the agglomerates may be fully or partially oxidized, thereby resulting in an overall mixture of copper metal, Cu₂O and CuO species on the fiber fabric surface. The copper metal to oxide ratio may reside in the 5-15% range.

Agglomerates of copper nanoparticles in the 50-200 nm size range with a monolayer of amine surfactants on their surfaces and having an agglomerate size of 1-35 microns were adhered to a 100% polypropylene fabric (melt-blown) with an average fiber diameter of about 10 microns using an epoxy adhesive. This may be done via spray coating onto the fibers. The adhesive layer was about 35-150 nm thick, and the metal nanoparticle agglomerates were partially embedded in the adhesive layer with a substantial portion still exposed.

The areal coverage of the agglomerates on the fiber surfaces is about 5-30%. The copper loading upon the fabric ranged from about 0.7 mg/in² to about 1.6 mg/in². Depending on size, some of the agglomerates may be fully or partially oxidized, thereby resulting in an overall mixture of copper metal, Cu₂O and CuO species on the fiber surface. The copper metal to oxide ratio may reside in the 1-5% range.

Agglomerates of copper nanoparticles in the 35-200 nm size range with a monolayer of amine surfactants on their surfaces and having an agglomerate size of 3-25 microns were adhered to a 100% cotton fabric with an average fiber diameter of about 10 microns using a styrene acrylic acid block copolymer adhesive. This may be done via spray coating onto the fibers. The adhesive layer was about 50-150 nm thick, and the metal nanoparticle agglomerates were partially embedded in the adhesive layer with a substantial portion still exposed. The areal coverage of the agglomerates upon the fiber surfaces was about 40-75%. The copper loading upon the fabric ranged from about 2.7 mg/in² to about 4.5 mg/in². Depending on size, some of the agglomerates may be fully or partially oxidized, thereby resulting in an overall mixture of copper metal, Cu₂O and CuO species on the fiber surface. The copper metal to oxide ratio may be in the 3-25% range.

Stability testing. A 6″×6″ sheet of fabric was tumbled in water for 8 hours. Only 1.4% of the available copper by weight (0.54 mg) was released into the water.

Shedding was also determined by exposing the fabric to simulated breathing conditions (8.4 and 40.8 m/min face velocity gas flow) and analyzing a filter trap for liberated copper by SEM or EDS. The shedding tests did not reveal detectable liberation of copper from the fabric.

VOCs. No volatile organic compounds (VOCs) from a battery of 70 standard VOCs were detected as being released from the fabric when tested under standard conditions.

Direct exposure to cell growth media. A piece of fabric was first soaked in supplemented cell growth media for up to an hour and then removed. Thereafter, Vero cells or Calu-3 lung epithelial cells were immersed in the cell growth media and incubated overnight in a CO₂ incubator. Cell viability was determined by assessing ATP production using a luminescence assy. The luminescence assay did not reveal a substantial change in cell viability.

Efficacy. Efficacy of the fabric against a panel of bacterial and viral pathogens was tested. The panel included gram-positive, gram-negative, and antibiotic-resistant bacteria, bacteriophages as representatives of non-enveloped viruses, enveloped viruses such as H1N1 flu, H3N2 flu, and SARS-CoV-2, and non-enveloped viruses such as feline calicivirus. In all cases, >99% kill rates were observed within 30 seconds, and full efficacy was maintained over 15 days of repeated daily exposure. The efficacy was >99.9% over a standard EPA exposure time of 2 hours against Staphylococcus aureus (ATCC 6538), Enterobacter aerogenes (ATCC 13048), Pseudomonas aeruginosa (ATCC 15442), Methicillin Resistant Staphylococcus aureus MRSA (ATCC 33592), and Escherichia coli 0157:H7 (ATCC 35150). The fabric maintained substantially 100% of the original efficacy against repeated viral inocculations (27M PFUs; H1N1, H3N2 and feline calicivirus) or bacterial loads introduced to the fabric over the course of 30 days. The fabric maintained >99.9% efficacy against Staphylococcus aureus and Klebsiella aerogenes after months of daily high-touch use and moisture exposure with visible wear. An inactivation rate of substantially 100% was realized against human wound pathogens such as Acinetobacter baumannii, Klebsiella pneumonia, Pseudomonas aeruginosa, Enterococcus faecalis, Methicillin-resistant Staphylococcus aureus (MRSA), and Staphylococcus epidermidis over 24 hours.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the features of the present disclosure are presented herein. Not all features of a physical implementation are described or shown in this application for the sake of clarity. It is understood that in the development of a physical embodiment incorporating the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The disclosure herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A spray formulation comprising:

2. an aerosolizable fluid medium; and

3. a plurality of metal nanoparticle agglomerates dispersed in the aerosolizable fluid medium.

4. The spray formulation of claim 1, wherein metal nanoparticles within the metal nanoparticle agglomerates comprise copper nanoparticles, silver nanoparticles, or any combination thereof.

5. The spray formulation of claim 2, further comprising:

6. NiO, ZnO, TiO₂ or any combination thereof.

7. The spray formulation of claim 2, wherein the metal nanoparticle agglomerates comprise copper nanoparticles, and the copper nanoparticles comprise metallic copper and a coating comprising Cu₂O, CuO or any combination thereof.

8. The spray formulation of claim 1, wherein the metal nanoparticle agglomerates comprise metal nanoparticles, in which at least a majority of the metal nanoparticles range from about 50 nm to about 250 nm in size.

9. The spray formulation of claim 1, wherein the metal nanoparticle agglomerates range from about 500 nm to about 35 microns in size.

10. The spray formulation of claim 1, wherein the aerosolizable fluid medium comprises one or more alcohols and optionally water.

11. The spray formulation of claim 7, wherein the aerosolizable fluid medium comprises an aerosol propellant.

12. The spray formulation of claim 1, wherein the aerosolizable fluid medium comprises an aerosol propellant.

13. The spray formulation of claim 1, further comprising:

14. an adhesive.

15. Personal protective equipment having the spray formulation of claim 1 deposited thereon.

16. A touch surface having the spray formulation of claim 1 deposited thereon.

17. A method comprising:

18. providing a surface in need of disinfection; and
19. applying a spray formulation on the surface, the spray formulation comprising an aerosolizable fluid medium and a plurality of metal nanoparticle agglomerates dispersed in the aerosolizable fluid medium.

20. The method of claim 13, wherein the spray formulation is applied to the surface by pumping or gas pressurization.

21. The method of claim 13, wherein the spray formulation is applied to the surface by dispensation from an aerosol spray can.

22. The method of claim 13, wherein metal nanoparticles within the metal nanoparticle agglomerates comprise copper nanoparticles, silver nanoparticles, or any combination thereof.

23. The method of claim 16, wherein the spray formulation further comprises NiO, ZnO, TiO₂ or any combination thereof.

24. The method of claim 16, wherein the metal nanoparticle agglomerates comprise copper nanoparticles, and the copper nanoparticles comprise metallic copper and a coating comprising Cu₂O, CuO or any combination thereof.

25. The method of claim 13, wherein the metal nanoparticle agglomerates comprise metal nanoparticles, in which the metal nanoparticles range in size from about 50 nm to about 250 nm

26. The method of claim 13, wherein the metal nanoparticle agglomerates range from about 500 nm to about 35 microns in size.

27. The method of claim 13, wherein the aerosolizable fluid medium comprises one or more alcohols and optionally water.

28. The method of claim 20, wherein the aerosolizable fluid medium comprises an aerosol propellant.

29. The method of claim 13, wherein the aerosolizable fluid medium comprises an aerosol propellant.

30. The method of claim 13, wherein the spray formulation further comprises an adhesive.

31. An aerosol spray can loaded with the spray formulation of claim 8.
